(19) United States
(12) Patent Application Publication
(10) Pub. No.: US 2021/0300096 A1
(43) Pub. Date: Sep. 30, 2021

(54) ALTERATIONS OF PRINT DRIVE ASSEMBLIES

(71) Applicant: Hewlett-Packard Development Company, L.P., Spring, TX (US)

(72) Inventors: Sean Daniel FitzGerald, Boise, ID (US); Gabriel Scott McDaniel, Boise, ID (US)

(73) Assignee: Hewlett-Packard Development Company, L.P., Spring, TX (US)

(21) Appl. No.: 17/262,384

(22) PCT Filed: Nov. 9, 2018
(86) PCT No.: PCT/US2018/060010

§ 371 Date: Jan. 22, 2021

(51) Int. Cl. B41J 29/38; B29C 64/227

(52) U.S. Cl. CPC B41J 29/38; B29C 64/227

(57) ABSTRACT

In some examples, a non-transitory machine-readable storage medium having stored thereon machine-readable instructions to cause a processing resource to: detect an alteration of a print drive assembly, alter a state of a first drive motor associated with the print drive assembly based the detected alteration of the print drive assembly, and alter a state of a drive axis associated with the print drive assembly based on the detected alteration of the print drive assembly.

### BACKGROUND

Printing systems, such as printers, copiers, etc., may generate text or images on to print media (e.g., paper, plastic, etc.). Printing systems generally include a stacking region for the collection of print media. The stacking region may be an output region where a user may receive the print media. In some examples, printing systems may include a finishing device where print media may be collected for a finishing process, such as stapling, three-hole punching, etc. The printing systems may be connected by a media pathway to a finisher that may perform a finishing process on the printable media.

### BRIEF DESCRIPTION OF THE DRAWINGS

FIG. 1 illustrates an example of a memory resource for altering print drive assemblies consistent with the disclosure.

FIG. 2 illustrates an example of a system for altering print drive assemblies consistent with the disclosure.

FIG. 3 illustrates an example of a system for altering print drive assemblies consistent with the disclosure.

FIG. 4 illustrates an example of a system for altering print drive assemblies consistent with the disclosure.

FIG. 5 illustrates an example of a system for altering print drive assemblies consistent with the disclosure.

FIG. 6 illustrates an example of a system for altering print drive assemblies consistent with the disclosure.

### DETAILED DESCRIPTION

A printing device or printing system can include drive motors that can be utilized to mechanically move or apply a force to a drive axis of the printing device. In some examples, the drive axis can be coupled to a plurality of devices to be driven by the drive axis. As used herein, a drive motor can include a motor that can generate mechanical power. For example, a drive motor can include an electric motor that can convert electricity into a rotational force and/or rotational torque. In some examples, the mechanical power can be provided to a drive axis and/or directly to a device of the printing device.

As used herein, a drive axis can include a device that can convert the mechanical power provided by the drive motor to a different device. For example, a drive axis can include a gear that is coupled to the drive motor. In this example, the gear coupled to the drive motor can convert the mechanical power from the drive motor to a different gear and/or different device. In some examples, a printing device can utilize a single drive motor to provide mechanical power to a plurality of devices through the drive axis. For example, a printing device can utilize a single drive motor that is utilized to provide mechanical power for a developer, a drum, a fuser roller, a paper mechanism, and/or other devices for generating print media through the drive axis coupled between the single drive motor and the devices.

In some examples, a printing device can utilize a separate drive motor for each of a plurality of devices. For example, a first drive motor can be coupled to a developer of the printing device, a second drive motor can be coupled to a drum of the printing device, and a third drive motor can be coupled to a different device. In some examples, printing devices that utilize a plurality of drive motors can provide relatively higher performance compared to printing devices that utilize fewer drive motors. For example, a printing device that utilizes a separate drive motor for a developer and a drum can provide relatively higher performance compared to a printing device that utilizes a single drive motor for the developer and the drum. In some examples, the higher performance can include a relatively higher consumable life of the printing device and//or print drive motors, print substance utilization improvements, power consumption improvements, among other performance increases.

The present disclosure relates to altering print drive assemblies of printing devices. In some examples, a print drive assembly can include a number drive motors and a drive axis to mechanically drive a number of devices. In some examples, the present disclosure includes systems and devices for altering the print drive assembly from a single drive motor and drive axis providing mechanical power to a plurality of devices to a plurality of drive motors interpedently providing mechanical power to the plurality of devices. For example, a printing device can include a single drive coupled to a drive axis to provide mechanical power to a drum and a developer of the printing device. In this example, an additional drive motor can be installed to provide mechanical power to the drum while the single drive motor provides mechanical power to the developer. In this example, a portion of the drive axis can be altered to accommodate the additional drive motor into the printing device.

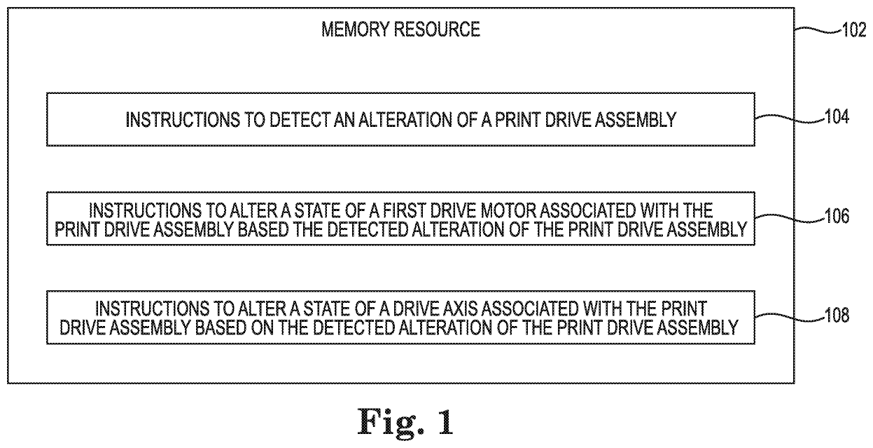

FIG. 1 illustrates an example of a memory resource 102 for altering print drive assemblies consistent with the disclosure. In some examples, the memory resource 102 can be part of a computing device that includes a processing resource to execute instructions stored on the memory resource 102, For example, a computing device can include a processing resource and a memory resource 102 to store instructions that are executable by the processing resource to perform a number of functions. In some examples, a memory resource 102 can be utilized to store instructions 104, 106, 108 that can be executed by a processing resource to perform functions described herein. In some examples, the processing resource can be coupled to the memory resource 102 via a connection channel. A processing resource may be a central processing unit (CPU), microprocessor, and/or other hardware device suitable for retrieval and execution of instructions stored in memory resource 102.

A memory resource 102 may be any electronic, magnetic, optical, or other physical storage device that stores executable instructions 104, 106, 108. Thus, memory resource 102 may be, for example, Random Access Memory (RAM), an Electrically-Erasable Programmable Read-Only Memory (EEPROM), a storage drive, an optical disc, a flash drive, a solid state drive, and the like. The executable instructions 104, 106, 108 may be stored on the memory resource 102. The memory resource 102 may be a portable, external or remote storage medium, for example, that allows the instructions 104, 106, 108 to be downloaded from the portable/external/remote storage medium. For example, the instructions 104, 106, 108 can be received from a mobile device through a wireless connection such as a wireless Internet connection and/or a wireless cellular connection. In this situation, the executable instructions 104, 106, 108 may be part of an “installation package”. As described herein, memory resource 102 may be encoded with executable instructions 104, 106, 108 for altering print drive assemblies as described herein.

In some examples, the memory resource 102 can include instructions 104 that when executed by a processing resource can detect an alteration of a print drive assembly. As described herein, a print drive assembly can be altered with the addition or removal of a drive motor or other component of the print drive assembly (e.g., gear, motor, sprocket, etc.). In some examples, the alteration of the print drive assembly can be detected when a component of the print drive assembly is connected to an interface (e.g., computing interface, electrical interface, etc.) of the printing device. For example, when the alteration is the addition of a drive motor, the instructions 104 can detect when the drive motor is communicatively coupled and/or electrically coupled to the interface.

In some examples, the drive motor can provide a signal to the interface and the signal can be utilized to detect that an alteration has occurred. In some examples, the signal can include information relating to the drive motor. For example, the signal can include information relating to: the type of component that is coupled to the interface, a state of the printing device that can utilize the component that is coupled to the interface, and/or other types of information that can be utilized to alter a state of the printing device such that the printing device can utilize the component coupled to the interface. For example, the signal can be utilized by a computing device of the printing device to determine how the print drive assembly is to be altered to accept the alteration.

In some examples, the interface can be utilized to provide electrical power to an added drive motor. That is, the interface can be utilized to provide power to an added drive motor and utilized to provide a signal from the drive motor to determine information related to the drive motor. In some examples, a drive motor can be added to the print drive assembly and coupled to the interface to activate the drive motor. In this example, the drive motor can provide a signal to the interface to notify a computing device utilizing the memory resource 102 that the drive motor is activated and if a state change should occur for the printing device.

As used herein, a state of a printing device or a state of the print drive assembly can include an overall design of the print drive assembly such that the components of the print drive assembly can be assigned to be activated or deactivated. For example, in a first state with a single drive motor, a first gear and a second gear of the print drive assembly can be activated to allow the single drive motor to provide mechanical power through the first gear and the second gear. In this example, in a second state with two drive motors, the first gear can remain activated and the second gear can be deactivated to allow a second drive motor to replace the second gear.

As used herein, an activated gear or component can be a component that is utilized by the print drive assembly and a deactivated gear or component can be a component that is not utilized by the print drive assembly. In some examples, the printing device can include a clutching mechanism to activate and deactivate particular gears or components of the print drive assembly. For example, a gear that is activated can be connected to a drive motor and receive the mechanical power from the drive motor. In this example, a clutching mechanism can be utilized to disconnect the gear from the drive motor and/or from a different component of the print drive assembly such that the gear is no longer receiving and/or providing mechanical power.

In some examples, the memory resource 102 can include instructions 106 that when executed by a processing resource can alter a state of a first drive motor associated with the print drive assembly based the detected alteration of the print drive assembly. As described herein, the alteration of the print drive assembly can alter a state of components of the print drive assembly such as gears. For example, a gear can be deactivated from the print drive assembly in response to the detected alteration of the print drive assembly. In this example, the state of the first drive motor can also be altered to accommodate the alteration of the print drive assembly. For example, the first drive motor can be responsible for: providing mechanical power for three devices of the printing device in a first state, providing mechanical power for two devices of the printing device in a second state, and/or providing mechanical power for one device of the printing device in a third state.

In some examples, the first drive motor can be coupled to a drive axis that is coupled to the devices of the printing device that utilize the mechanical power of the drive motor. As described herein, the gears or components of the drive axis can be altered to different states (e.g., activated, deactivated, etc.) based on the signal received from a drive motor added to the print drive assembly. In a similar way, the state of the first drive motor can be altered based on the signal or information received from the drive motor added or coupled to the interface. For example, a state of the drive motor can include an activation time, a deactivation time, a rotational speed, a rotational torque, a current usage, a failure, among other features of an electric motor. In this example, the state of the drive motor can be altered to alter one or more of the features of the first drive motor such that a second drive motor can be incorporated into the print drive assembly.

In some examples, a state of the first drive motor can be altered to adjust a feature of the first drive motor to operate within the altered print drive assembly. For example, when a second drive motor is added to the print drive assembly, the features of the first drive motor can be altered since the first drive motor may provide mechanical power to fewer devices of the printing device. For example, the first drive motor may no longer provide mechanical power to a device that is receiving mechanical power from the second drive motor. In addition, the first drive motor may provide mechanical power to fewer components or gears of a drive axis. For example, when a second drive motor is added to the print drive assembly, a number of gears or components can be deactivated and no longer receive mechanical power from the first drive motor. In this example, the features of the first drive motor can be altered since the first drive motor is no longer providing mechanical power to the number of gears or components.

In some examples, the memory resource 102 can include instructions 108 that when executed by a processing resource can alter a state of a drive axis associated with the print drive assembly based on the detected alteration of the print drive assembly. In some examples, the instructions 108 can include instructions to deactivate the drive axis from the print drive assembly. As described herein, the drive axis can include components to transfer the mechanical power generated by the first drive motor and/or other drive motor to devices of the printing device. For example, the drive axis can include a plurality of gears and/or components to transfer mechanical power from the first drive motor to a drum and a developer of the printing device.

In some examples, altering the state of a drive motor can include instructions to alter a performance of the drive motor to accommodate a different quantity of devices utilizing the drive motor through the print drive assembly. For example, a drum drive motor can be added to the printing device and the drive motor may no longer provide mechanical power for the drum of the printing device. That is, adding drive motors can change the quantity of devices that the drive motor is utilized to run.

In some example, the memory resource 102 can include instructions to receive a signal from a device coupled to a printing device associated with the print drive assembly. As described herein, the signal from the device coupled to the printing device can be a device, such as a drive motor, to be added to the print drive assembly. In some examples, the signal can include information relating to the device (e.g., information about the device type, manufacturer information, etc.).

In some examples, the memory resource 102 can include instructions to determine a plurality of devices associated with the print drive assembly to be altered based on the signal from the device. As described further here, devices within the printing device may be altered to accommodate an added device such as a drive motor. For example, a portion of a drive axis can be deactivated to accommodate a drive motor that is added to the print drive assembly.

In some examples, the memory resource 102 can include instructions to alter a state of the plurality of devices to accommodate the device coupled to the printing device. As described herein, the printing device can include state information for a plurality of devices to be added to the printing device. In some examples, the state information can include information for altering a state or setting for a plurality of devices to accommodate the added device.

As described herein, the altered print drive assembly can alter a state of the gears and/or components of the drive axis to allow the alteration to the print drive assembly to function. For example, the alteration to the print drive assembly can include adding a second print drive motor to provide mechanical power to a first device. In this example, a portion of the print drive axis that transferred mechanical power from the first drive motor to the first device can be deactivated to allow the second drive motor to provide mechanical power to the first device.

In this way, a printing device can be altered to utilize additional drive motors and/or components to provide mechanical power to devices of the printing device. In some examples, the printing device can be customized to provide better performance for particular types of jobs and reduce wear on particular components of the print drive assembly by altering the print drive assembly based on a particular type of job that is more commonly performed by a particular printing device.

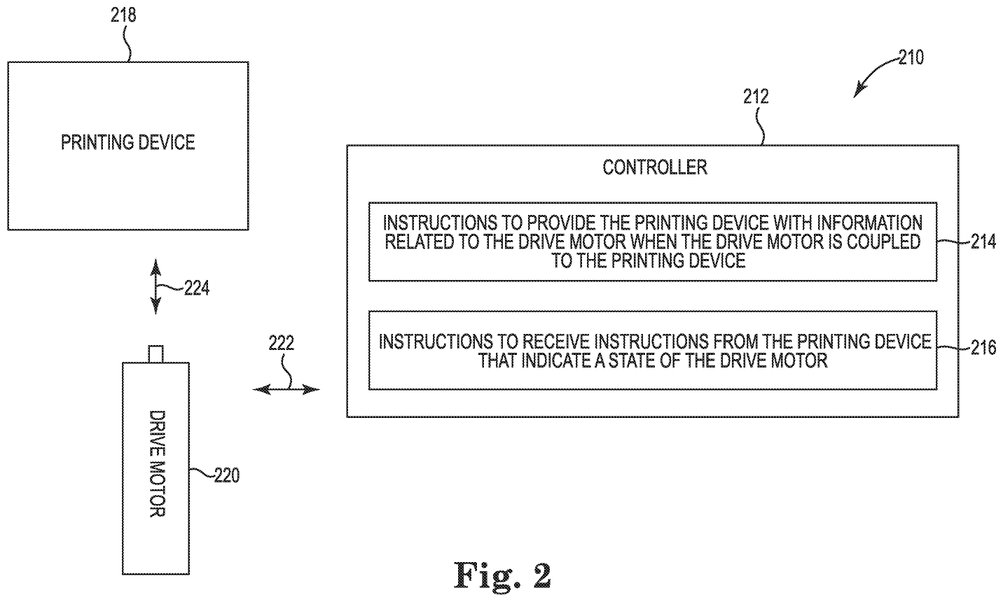

FIG. 2 illustrates an example of a system 210 for altering print drive assemblies consistent with the disclosure. In some examples, the system 210 can include a printing device 218. As described herein, the printing device 218 can be utilized to generate print media. For example, the printing device 218 can be a laser printer, copier, inkjet printer, or three dimensional (3D) printer. In some examples, the printing device 218 can utilize drive motors, such as drive motor 220 (e.g., drive motor assembly, etc.), to generate mechanical power that can be utilized by components or devices of the printing device 218.

In some examples, the system 210 can include a controller 212. The controller 212 can be part of a computing device that includes a processing resource to execute instructions stored on a memory resource. In other examples, the controller 212 can include instructions 214, 216 that can be executed by programming circuitry or logic such as an application specific integrated circuit (ASIC). In some examples, the controller 212 can be positioned within the drive motor 220 to communicate with the printing device 218 by sending and/or receiving signals with the printing device 218. For example, the controller 212 can be communicatively coupled to the printing device 218 through a connection channel 222. In this example, the controller 212 can receive and/or send data, instructions, notifications, etc. with the printing device 218 through the connection channel 222. In some examples, the connection channel 222 can be a wired connection and/or a wireless connection.

In some examples, the controller 212 can include instructions 214 that when executed can provide the printing device 218 with information related to the drive motor 220 when the drive motor 220 is coupled to the printing device 218. In some examples, the drive motor 220 can be coupled to the printing device 218 through a connection channel 224. As described herein, the drive motor 220 can be coupled to the printing device 218 through an interface that can receive the connection channel 224. In some examples, the connection channel 224 can provide electrical power to the drive motor 224 through a power supply of the printing device 218 when the connection channel 224 is coupled to the interface of the printing device 218. In addition, the connection channel 224 can provide a communication channel for the controller 212 to provide the printing device 218 with information related to the drive motor 220.

In some examples, the information provided to the printing device 218 from the controller 212 can be utilized by the printing device 218 to alter a state of the printing device 218, a drive motor currently installed on the printing device 218, and/or a drive axis of the printing device 218. As described herein, the drive motor 220 can be a modular addition to the printing device 218 that can perform functions that were previously performed by other drive motors and/or a drive axis of the printing device 218. In some examples, the information related to the drive motor includes information relating to a portion of the print drive assembly and devices of the printing device that the drive motor operates when installed with the print drive assembly. Thus, the printing device 218 can utilize the information provided by the controller 212 to alter settings of the printing device 218 to allow the drive motor 220 to function as part of the printing device 218.

In some examples, the printing device 218 can utilize a first state when a first drive motor is utilized to provide mechanical power to run a developer of the printing device 218, In this example, the information from the drive motor 220 can include information that the drive motor 220 is a developer drive motor for the developer of the printing device 218. In this example, the printing device 218 can alter from the first state to a second state to allow the drive motor 220 to provide mechanical power to the developer of the printing device 218.

In some examples, the printing device 218 can alter a state of a plurality of devices to allow the drive motor 220 to provide mechanical power to a portion of the plurality of devices of the printing device 218. For example, the printing device 218 can alter settings of previously installed drive motors such that the speed and/or torque of the previously installed drive motors is based on devices to be run by the previously installed drive motors, which don't include the devices that are to be run by the drive motor 220. In this example, the printing device 218 can alter settings of other electronic devices associated with the printing device 218, such as, but not limited to: fusers, rollers, print heads, among other types of electronic or mechanical devices associated with the printing device 218. In another example, a portion of the drive axis can be altered or deactivated to allow the drive motor 220 to provide mechanical power to devices that previously utilized to the portion of the drive axis.

In some examples, the information provided to printing device 218 alters a state of the printing device 218 to allow the printing device 218 to utilize the drive motor 220. For example, the information can include instructions that can be executed by the printing device 218 to alter the state of the printing device 218 as described herein. In these examples, the instructions can be based on the type of the drive motor 220. For example, the information can include instructions that can alter the state of the printing device 218 based on the device or devices that the drive motor 220 is to provide mechanical power to within the printing device 218. In another example, the information can include instructions that can alter a state of the printing device 218 based on print process components that include features, mechanisms, or operating parameters that can be changed in order to operate properly in conjunction with the drive motor 220.

In some examples, the controller 212 can include instructions 216 that when executed can receive instructions from the printing device 218 that indicate a state of the drive motor 220. As used herein, a state of the drive motor 220 can include settings of the drive motor 220. For example, the settings of the drive motor 220 can include, but are not limited to, a speed of the drive motor 220, a torque of the drive motor 220, an activation time or start time for the drive motor 220, ramp up cycle, ramp down cycle, and/or a deactivation time or stop time for the drive motor 220. In some examples, the received instructions from the printing device 218 can provide operational instructions based on a current layout or structure of the printing device 218. For example, the layout or structure of the printing device 218 can include the layout of the print drive assembly devices installed on the printing device 218. In this example, a print drive assembly with a single drive motor can have a different layout or structure than a print drive assembly with a plurality of drive motors. Thus, the printing device 218 can determine a layout or structure of the print drive assembly with the drive motor 220 and provide instructions to the drive motor 220 to operate within the print drive assembly. As described further herein, the received instructions from the printing device 218 can be provided to the printing device 218 from the drive motor 220 and/or other device.

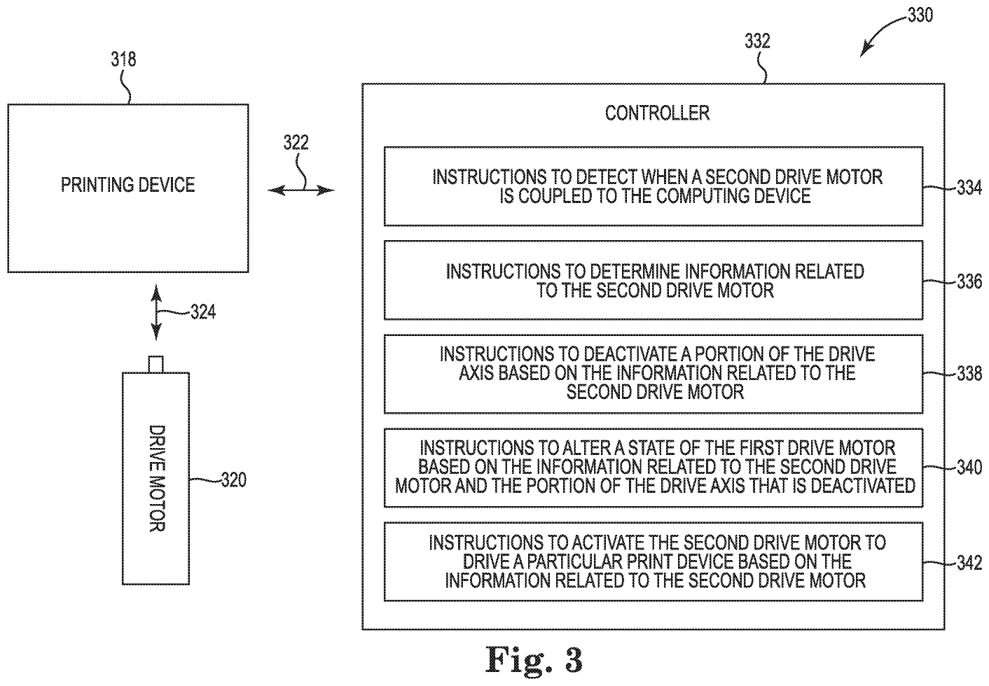

FIG. 3 illustrates an example of a system 330 for altering print drive assemblies consistent with the disclosure. The system 330 can be a printing system that includes a printing device 318 to generate images on a print media. For example, the printing device 318 can be a device that can deposit a printing substance on a print media such as paper. In some examples, the printing device 318 can include previously installed drive motors that can be coupled to a drive axis to provide mechanical power to a plurality of devices (e.g., print drum, print developer, etc.) within the printing device 318 to generate the images on the print media. For example, the printing device 318 can include a print drive assembly comprising a first drive motor coupled to a drive axis to drive the print devices.

In some examples, the system 330 can include a computing device 332. The computing device 332 can include a processing resource to execute instructions stored on a memory resource. For example, the computing device can include instructions 334, 336, 338, 340, 342 that can be stored on a memory resource. In this example, the instructions 334, 336, 338, 340, 342 can be executed by a processing resource to perform functions described herein.

In some examples, the computing device 332 can include instructions 334 that can be stored on a memory resource and when executed by a processing resource can detect when a second drive motor 320 is coupled to the computing device 332. As described herein, the computing device 332 can detect when the second drive motor 320 is coupled to the computing device 332 when the second drive motor 320 is coupled to an interface through a connection channel 324. In some examples, the computing device 332 can be coupled to the printing device 318 through a connection channel 322 and receive a signal or information relating to the second drive motor 320 through the connection channel 324 and/or connection channel 322.

In some examples, the second drive motor 320 can send a signal to the computing device 332 of the printing device 318 through the connection channel 324. As described herein, the signal can include information relating to the second drive motor 320. In other examples, the signal can be utilized by the computing device 332 to alter a state of the printing device 318. In another example, the information can include instructions that can alter a state of the printing device 318 based on print process components that include features, mechanisms, or operating parameters that can be changed in order to operate properly in conjunction with the drive motor 320.

In some examples, the computing device 332 can include instructions 336 that can be stored on a memory resource and when executed by a processing resource can determine information related to the second drive motor 320. In some examples, the information related to the second drive motor 320 includes the particular print device (e.g., drum, developer, etc.) to be driven by the second drive motor 320. As described herein, the information related to the second drive motor 320 can include a type of the second drive motor 320, a model of the second drive motor 320, manufacturer specifications of the second drive motor 320, a device to be drive by the second drive motor 320, etc. In some examples, the second drive motor 320 can send a signal to the computing device 332 that includes the information. In other examples, the second drive motor 320 can include a circuit assembly that can store the information. In these examples, the computing device 332 can be utilized to extract the stored information on the circuit assembly or the second drive motor 320 can provide the information to the computing device 332 that is stored on the circuit assembly.

In some examples, the computing device 332 can include instructions 338 that can be stored on a memory resource and when executed by a processing resource can deactivate a portion of the drive axis based on the information related to the second drive motor 320. As described herein, a portion of the drive axis can be utilized to transfer mechanical power from the first drive motor to a particular device of the printing device 318. In some examples, the portion of the drive axis can be deactivated when the second drive motor 320 is to provide mechanical power for the particular device. That is, the portion of the drive axis can be deactivated and replaced with the second drive motor 320 to provide mechanical power to the particular device.

In some examples, deactivating the portion of the drive axis can include deactivating one or more gears of the drive axis that transfer mechanical power from the first drive motor to the particular device. In some examples, a clutching mechanism can be utilized to deactivate the portion of the drive axis. As used herein, the clutching mechanism can be utilized to prevent the portion of the drive axis from interacting with the first drive motor, the second drive motor 320, and/or the particular device. In some examples, the instructions 338 to deactivate the portion of the drive axis can include instructions to disconnect a gear or drive component (e.g., belt, etc.) of the drive axis from the first drive motor and a printing device 318. In some examples, the first drive motor is coupled to the particular print device through the portion of the drive axis that is deactivated and drives the particular print device until the second drive motor 320 is detected.

In some examples, the computing device 332 can include instructions 340 that can be stored on a memory resource and when executed by a processing resource can alter a state of the first drive motor based on the information related to the second drive motor 320 and the portion of the drive axis that is deactivated. In some examples, the state of the first drive motor and/or the state of the second drive motor 320 can include settings of the first drive motor and/or settings of the second drive motor 320. For example, the settings of the first drive motor can include, but are not limited to, a speed of the first drive motor, a torque of the first drive motor, an activation time of the first drive motor, and/or a deactivation time of the first drive motor.

As described herein, when the second drive motor 320 is utilized to provide mechanical power to a particular device of the printing device 318, the first drive motor may no longer have to provide mechanical power to the particular device. In some examples, the state or settings of the first drive motor can be altered since the first drive motor no longer has to provide mechanical power to the particular device. For example, the first drive motor may not have to be activated to start a ramp up cycle to provide a steady state for a developer when the second drive motor 320 is providing mechanical power to the developer. In this example, the load of the first drive motor can be lowered since the first drive motor no longer has to run the developer. In addition, the first drive motor may not have to be activated while the developer is being utilized. Thus, utilizing the second drive motor 320 can lower the wear on the first drive motor and/or the drive axis coupled to the first drive motor.

In some examples, the computing device 332 can include instructions 342 that can be stored on a memory resource and when executed by a processing resource can activate the second drive motor 320 to drive a particular print device based on the information related to the second drive motor 320, In some examples, once the state of the printing device 318 has been altered to receive the second drive motor 320, the second drive motor 320 can be activated and utilized for future use with the printing device 318. As described herein, the altered state can be based on the information from the second drive motor 320 and alterations of the state of the printing device 318 can alter the drive axis, the first drive motor, and/or other devices of the printing device 318.

In some examples, the computing device 332 can include instructions to activate the portion of the drive axis and alter the state of the first drive motor when the second drive motor 320 is disconnected from the computing device 332. In this way, the second drive motor 320 can be added to the system 330 and removed from the system 330 without preventing the printing device 318 from performing print jobs. In some examples, the portion of the drive axis can be activated utilizing the clutching mechanism to reposition or activated the previously deactivated gears or devices of the drive axis.

In some examples, the computing device 332 can include instructions to alter a state of the printing device 318 when the second drive motor 320 is activated. In some examples, altering the state of the printing device 318 can include altering firmware of the printing device 318. For example, the firmware of the printing device 318 can be altered to a state that recognizes a particular layout of the print drive assembly and/or drive axis. In some examples, the firmware can be updated such that a ramp up cycle of the printing device is initiated to accommodate the second drive motor 320.

The system 330 can be utilized to customize a print drive assembly of the printing device 318 when the printing device 318 was manufactured with a particular print drive assembly, That is, an end user can determine whether or not to add a second drive motor 320 or multiple additional drive motors based on how the printing device 318 is to be utilized. In some examples, the computing device 332 can determine a type of printing to be performed by the printing device 318 and generate notifications that the second drive motor 320 may extend a workable life of the first drive motor and/or increase performance of the printing device based on previous usage and settings of the printing device 318.

For example, the computing device 332 can monitor print jobs of the printing device 318 to determine if installing the second drive motor 320 would increase performance of the printing device 318 and/or reduce wear or usage of the first drive motor. That is, the computing device 332 can be utilized to increase performance and/or increase a workable life of the printing device 318 by generating notifications when additional drive motors such as the second drive motor 320 would likely result in an increased performance and/or workable life of the printing device 318 based on previous usage of the printing device 318.

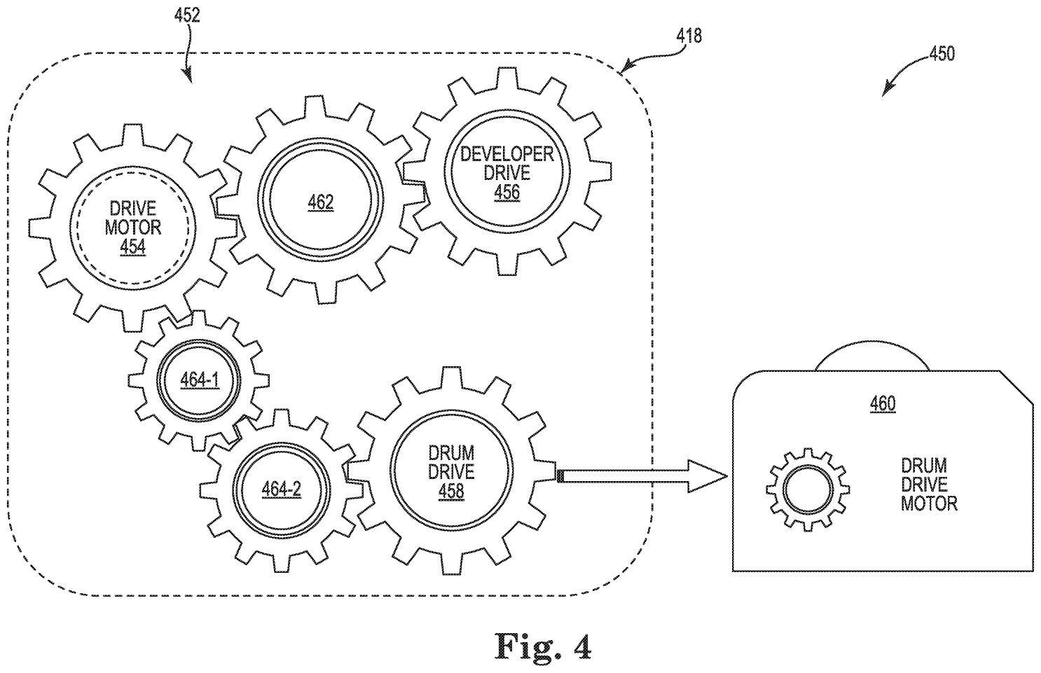

FIG. 4 illustrates an example of a system 450 for altering print drive assemblies consistent with the disclosure. In some examples, the system 450 can include a printing device 418. As described herein, the printing device 418 can be utilized to generate images on a print media. In some examples, the printing device 418 can include a drive axis 452, which can be part of a print drive assembly for the printing device 418. As described herein, the drive axis 452 can include gears 462, 464-1, 464-2 to transfer power from a drive motor 454 to devices such as a developer drive 456 to drive a developer or a drum drive 458 to drive a drum of the printing device 418.

In some examples, the drive motor 454 can be utilized to provide mechanical power to the drive axis 452. For example, the drive motor 454 can provide mechanical power to turn gears 462, 464-1, 464-2. In some examples, the drive motor 454 can provide mechanical power to a developer drive 456 coupled to a developer to run the developer by providing mechanical power to gear 462, which can transfer the mechanical power from the drive motor 454 to the developer drive 456. In a similar example, the drive motor 454 can provide mechanical power to a drum drive 458 through gear 464-1 and gear 464-2.

In some examples, the system 450 can illustrate when an additional drive motor is added to the printing device 418. In this example, a drum drive motor 460 can be the additional drive motor (e.g., second drive motor, etc.) that is added to the printing device 418 to provide mechanical power to the drum drive 458. As described herein, the drum drive motor 460 can be coupled to and/or installed on the printing device 418. In some examples, the drum drive motor 460 can be coupled to an interface of the printing device 418. As described herein, the interface can provide electrical power to the drum drive motor 460 and/or allow communication between the drum drive motor 460 and the printing device 418.

In some examples, the printing device 418 can receive information from the drum drive motor 460 through a connection channel as described herein. For example, the printing device 418 can receive information that the drum drive motor 460 can be utilized to run a drum drive 458 and/or drum of the printing device 418. In some examples, the information can include a state the printing device 418 can alter in order to receive and utilize the drum drive motor 460. For example, the information can describe that the printing device 418 should alter from a first state to a second state. In this example, the first state can utilize gears 464-1, 464-2 to run the drum drive 458 utilizing the drive motor 454. In this example, the second state can utilize a clutching mechanism to deactivate the gears 464-1, 464-2 such that the drum drive motor 460 can run the drum drive 458 and/or drum of the printing device 418.

In some examples, the information from the drum drive motor 460 can include information about changing a state of the drive motor 454. For example, the drive motor 454 may no longer have to run the drum drive 458 and/or drum of the printing device 418. In this example, the drive motor 454 may not be activated when only the drum drive 458 and/or drum of the printing device 418 is activated. That is, the drive motor 454 can change to a state where the drive motor 454 does not provide mechanical power to the drum drive 458 and/or the drum of the printing device 418. In some examples, the drive motor 454 can be utilized less often and/or utilized at a lower speed or torque to increase a workable life of the drive motor 454 and/or increase a performance of the printing device 418 by utilizing the drive motor 454 to run the developer drive 456, but not the drum drive 458.

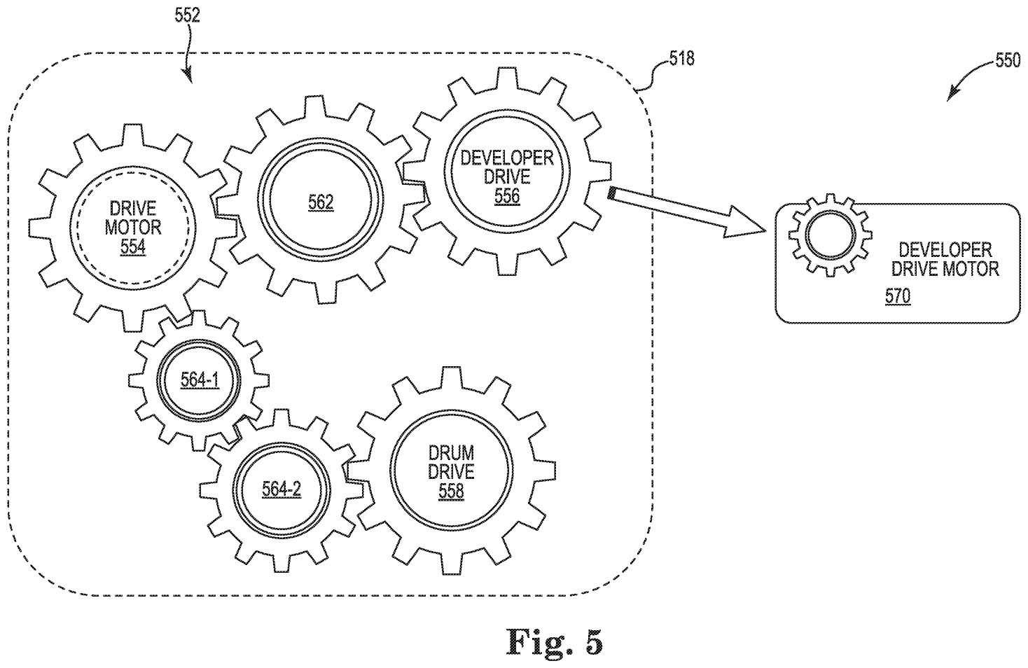

FIG. 5 illustrates an example of a system 550 for altering print drive assemblies consistent with the disclosure. In some examples, the system 550 can include a printing device 518. As described herein, the printing device 518 can be utilized to generate images on a print media. In some examples, the printing device 518 can include a drive axis 552, which can be part of a print drive assembly for the printing device 518. As described herein, the drive axis 552 can include gears 562, 564-1, 564-2 to transfer power from a drive motor 554 to devices such as a developer drive 556 to drive a developer or a drum drive 558 to drive a drum of the printing device 518.

In some examples, the drive motor 554 can be utilized to provide mechanical power to the drive axis 552. For example, the drive motor 554 can provide mechanical power to turn gears 562, 564-1, 564-2. In some examples, the drive motor 554 can provide mechanical power to a developer drive 556 coupled to a developer to run the developer by providing mechanical power to gear 562, which can transfer the mechanical power from the drive motor 554 to the developer drive 556. In a similar example, the drive motor 554 can provide mechanical power to a drum drive 558 through gear 564-1 and gear 564-2.

In some examples, the system 550 can illustrate when an additional drive motor is added to the printing device 518. In this example, a developer drive motor 570 can be the additional drive motor (e.g., second drive motor, etc.) that is added to the printing device 518 to provide mechanical power to the developer drive 556. As described herein, the developer drive motor 570 can be coupled to and/or installed on the printing device 518. In some examples, the developer drive motor 570 can be coupled to an interface of the printing device 518. As described herein, the interface can provide electrical power to the developer drive motor 570 and/or allow communication between the developer drive motor 570 and the printing device 518.

In some examples, the printing device 518 can receive information from the developer drive motor 570 through a connection channel as described herein. For example, the printing device 518 can receive information that the developer drive motor 570 can be utilized to run a developer drive and/or developer of the printing device 518. In some examples, the information can include a state the printing device 518 can alter in order to receive and utilize the developer drive motor 570. For example, the information can describe that the printing device 518 should alter from a first state to a third state. In this example, the first state can utilize the gear 562 to run the developer drive 556 utilizing the drive motor 554. In this example, the third state can utilize a clutching mechanism to deactivate the gear 562 such that the developer drive motor 570 can run the developer drive 556 and/or developer of the printing device 518.

In some examples, the information from the developer drive motor 570 can include information about changing a state of the drive motor 554. For example, the drive motor 554 may no longer have to run the developer drive 556 and/or developer of the printing device 518. In this example, the drive motor 554 may not be activated when only the developer drive 556 and/or developer of the printing device 518 is activated. That is, the drive motor 554 can change to a state where the drive motor 554 does not provide mechanical power to the developer drive 556 and/or the developer of the printing device 518. In some examples, the drive motor 554 can be utilized less often and/or utilized at a lower speed or torque to increase a workable life of the drive motor 554 and/or increase a performance of the printing device 518 by utilizing the drive motor 554 to run the drum drive 558, but not the developer drive 556.

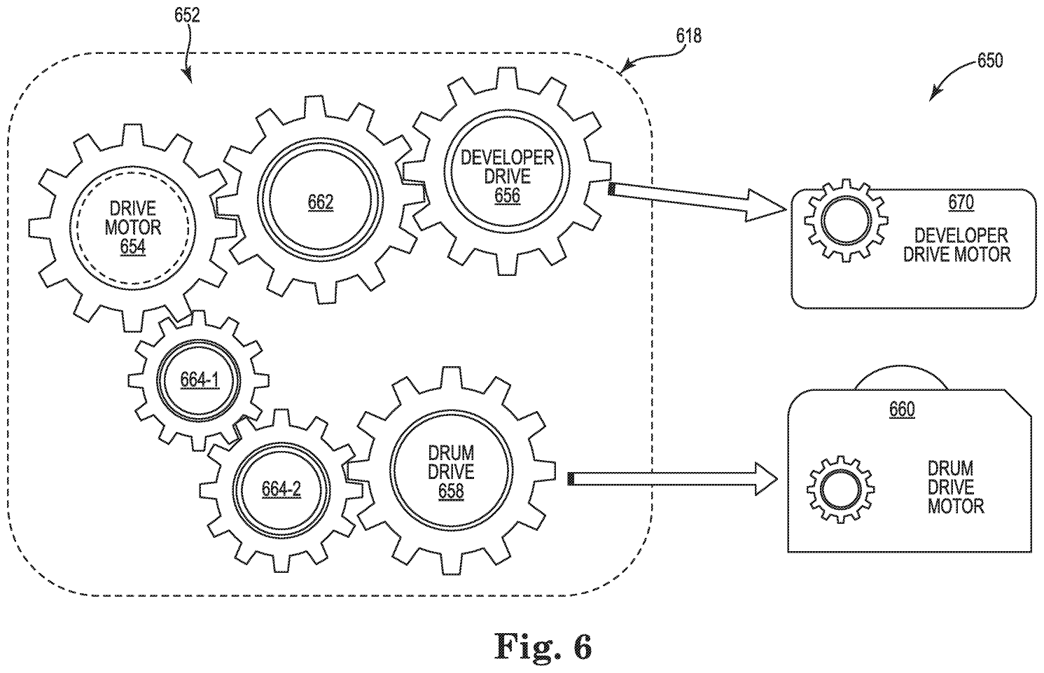

FIG. 6 illustrates an example of a system 650 for altering print drive assemblies consistent with the disclosure. In some examples, the system 650 can include a printing device 618. As described herein, the printing device 618 can be utilized to generate images on a print media. In some examples, the printing device 618 can include a drive axis 652, which can be part of a print drive assembly for the printing device 618. As described herein, the drive axis 652 can include gears 662, 664-1, 664-2 to transfer power from a drive motor 654 to devices such as a developer drive 656 to drive a developer, a drum drive 658 to drive a drum of the printing device 618, and/or other components of the printing device 618.

In some examples, the drive motor 654 can be utilized to provide mechanical power to the drive axis 652. For example, the drive motor 654 can provide mechanical power to turn gears 662, 664-1, 664-2. In some examples, the drive motor 654 can provide mechanical power to a developer drive 656 coupled to a developer to run the developer by providing mechanical power to gear 662, which can transfer the mechanical power from the drive motor 654 to the developer drive 656. In a similar example, the drive motor 654 can provide mechanical power to a drum drive 658 through gear 664-1 and gear 664-2.

In some examples, the system 550 can illustrate when additional drive motors are added to the printing device 618. In this example, a developer drive motor 670 can be a first additional drive motor (e.g., second drive motor, etc.) that is added to the printing device 618 to provide mechanical power to the developer drive 656. In addition, a drum drive motor 660 can be a second additional drive motor (e.g., third drive motor, etc.) that is added to the printing device 618 to provide mechanical power to the drum drive 658. As described herein, the developer drive motor 670 and the drum drive motor 660 can be coupled to and/or installed on the printing device 618. In some examples, the developer drive motor 670 and the drum drive motor 660 can be coupled to an interface of the printing device 618. As described herein, the interface can provide electrical power to the developer drive motor 570 and to the drum drive motor 660 and/or allow communication between the developer drive motor 570, the drum drive motor 660, and/or the printing device 618.

In some examples, the printing device 618 can receive information from the developer drive motor 670 and the drum drive motor 660 through a connection channel as described herein. For example, the printing device 618 can receive information that the developer drive motor 670 can be utilized to run a developer drive and/or developer of the printing device 618. In addition, the printing device 618 can receive information that the drum drive motor 660 can be utilized to run a drum drive 658 and/or drum of the printing device 618. In some examples, the information can include a state the printing device 618 can alter in order to receive and utilize the developer drive motor 670 and the drum drive motor 660 simultaneously. For example, the information can describe that the printing device 618 should alter from a first state to a fourth state. In this example, the first state can utilize the gear 662 to run the developer drive 656 utilizing the drive motor 654 and utilize the gears 664-1, 664-2 to run the drum drive 658 utilizing the drive motor 654. In this example, the fourth state can utilize a clutching mechanism to deactivate the gear 662 such that the developer drive motor 670 can run the developer drive 656 and/or developer of the printing device 618. In addition, the fourth state can utilize a clutching mechanism to deactivate the gears 664-1, 664-2 such that the drum drive motor 660 can run the drum drive 658 and/or drum of the printing device 618.

In some examples, the information from the developer drive motor 670 and/or drum drive motor 660 can include information about changing a state of the drive motor 654, For example, the drive motor 654 may no longer have to run the developer drive 656 and/or developer of the printing device 618 and also may no longer have to run the drum drive 658 and/or drum of the printing device 618, In this example, the drive motor 654 may not be activated when only the developer drive 656 and/or developer of the printing device 618 is activated. In addition, the drive motor 654 may not be activated when only the drum drive 658 and/or drum of the printing device 618 is activated. Furthermore, the drive motor 654 may not be activated when the developer drive 656 and drum drive 658 are activated simultaneously. That is, the drive motor 654 can change to a state where the drive motor 654 does not provide mechanical power to the developer drive 656 or the drum drive 658 of the printing device 618. In some examples, the drive motor 654 can be utilized less often and/or utilized at a lower speed or torque to increase a workable life of the drive motor 654 and/or increase a performance of the printing device 618 by utilizing the drive motor 654 to run other components while the developer drive motor 670 and the drum drive motor 660 run the developer drive 656 and drum drive 658 respectively.

In the foregoing detailed description of the disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the disclosure.

The figures herein follow a numbering convention in which the first digit corresponds to the drawing figure number and the remaining digits identify an element or component in the drawing. Similar elements or components between different figures can be identified by the use of similar digits. For example, 102 can reference element “02” in FIG. 1, and a similar element can be referenced as 202 in FIG. 2. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, the designator “N”, particularly with respect to reference numerals in the drawings, indicates that a plurality of the particular feature so designated can be included with examples of the disclosure. The designators can represent the same or different numbers of the particular features. Further, as used herein, “a plurality of” an element and/or feature can refer to more than one of such elements and/or features.

What is claimed:

1. A non-transitory machine-readable storage medium having stored thereon machine-readable instructions to cause a processing resource to:
detect an alteration of a print drive assembly;
alter a state of a first drive motor associated with the print drive assembly based the detected alteration of the print drive assembly; and
alter a state of a drive axis associated with the print drive assembly based on the detected alteration of the print drive assembly.

2. The medium of claim 1, wherein the alteration of the print device assembly is an addition of a second drive motor to the print drive assembly.

3. The medium of claim 1, wherein the instructions to alter the state of the drive axis includes instructions to deactivate the drive axis from the print drive assembly.

4. The medium of claim 1, wherein the instructions to alter a state of the first drive motor includes instructions to alter a performance of the drive motor to accommodate a different quantity of devices utilizing the drive motor through the print drive assembly.

5. The medium of claim 1, comprising instructions to alter a state of a device associated with a printing device based on the detected alteration of the print drive assembly when the device is associated with the alteration of the print drive assembly.

6. The medium of claim 1; comprising instructions to:
receive a signal from a device coupled to a printing device associated with the print drive assembly;
determine a plurality of devices associated with the print drive assembly to be altered based on the signal from the device;
alter a state of the plurality of devices to accommodate the device coupled to the printing device.

7. A device comprising:
a drive motor installable with a print drive assembly of a printing device;
a controller comprising instructions to:
provide the printing device with information related to the drive motor when the drive motor is coupled to the printing device; and
receive instructions from the printing device that indicate a state of the drive motor.

8. The device of claim 7, wherein the information provided to printing device alters a state of the printing device to allow the printing device to utilize the drive motor.

9. The device of claim 7, wherein the information related to the drive motor includes information relating to a portion of the print drive assembly and devices of the printing device that the drive motor operates when installed with the print drive assembly.

10. A system comprising:
a printing device comprising print devices to generate print media;
a print drive assembly comprising a first drive motor coupled to a drive axis to drive the print devices; and
a computing device comprising instructions to:
detect when a second drive motor is coupled to the computing device;
determine information related to the second drive motor;
deactivate a portion of the drive axis based on the information related to the second drive motor;
alter a state of the first drive motor based on the information related to the second drive motor and the portion of the drive axis that is deactivated; and
activate the second drive motor to drive a particular print device based on the information related to the second drive motor.

11. The system of claim 10, wherein the instructions to deactivate a portion of the drive axis includes instructions to disconnect a gear of the drive axis from the first drive motor and a print device.

12. The system of claim 10, wherein the first drive motor is coupled to the particular print device through the portion of the drive axis that is deactivated and drives the particular print device until the second drive motor is detected.

13. The system of claim 10, wherein the information related to the second drive motor includes the particular print device to be driven by the second drive motor.

14. The system of claim 10, comprising instructions to activate the portion of the drive axis and alter the state of the first drive motor when the second drive motor is disconnected from the computing device.

15. The system of claim 10, comprising instructions to alter a state of the printing device when the second drive motor is activated, wherein altering the state of the printing device includes altering firmware of the printing device.
